(19) United States
(12) Patent Application Publication
(10) Pub. No.: US 2011/0302506 A1
(43) Pub. Date: Dec. 8, 2011

(54) Method for Multi-User Collaboration on Visual Content Based Upon the Exchange of Session Data Objects Including New Parameters

(76) Inventors: Peter Noyes, Pasadena, CA (US); Benjamin Gunderson, Simi Valley, CA (US)

(21) Appl. No.: 12/795,299

(22) Filed: Jun. 7, 2010

(51) Int. Cl. G06F 3/01

(52) U.S. Cl. 715/753

(57) ABSTRACT

A method and system for coordinating visual content collaboration is disclosed. A collaboration session is first established from a server with a plurality of participant nodes. The visual content is transmitted to each of the participant nodes. A session data object is received by the collaboration server from a first one of the participant nodes, and may include view parameters specific to the display of the visual content thereon. A session record entry is generated from the received session data object, and is then transmitted from the collaboration server to one or more of the participant nodes. The view parameters are then applied to the receiving participant nodes.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to the facilitation of collaborative work efforts amongst multiple users. More particularly, the present disclosure relates to methods for collaborating on visual content based upon the exchange of session data objects including view parameters.

2. Related Art

The core of modern business is information, with its creation, distribution, and management being primary functions. Information or content can be presented in a variety of different ways, including word processing documents, spreadsheets, graphics, photographs, engineering drawings, architectural plans, and so forth. In electronic form, these are all generally referred to as documents, and may be generated by software applications that are specific thereto. A typical workflow in the enterprise involves various personnel collaborating to create, review, and/or edit such documents, and because of advancements in high-speed data communications and computing capabilities, these processes can involve remote personnel.

Due to the existence of many different computing platforms having a wide variety of operating systems, application programs, and processing and graphic display capabilities, it has been recognized by those in the art that a device-independent, resolution-independent file format was necessary to facilitate such exchange. In response to this need, the Portable Document Format (PDF), amongst other competing formats, has been developed.

The PDF standard is a combination of a number of technologies, including a simplified PostScript interpreter subsystem, a font embedding subsystem, and a storage subsystem. As those in the art will recognize, PostScript is a page description language for generating the layout and the graphics of a document. Further, per the requirements of the PDF storage subsystem, all elements of the document, including text, vector graphics, and raster (bitmap) graphics, collectively referred to herein as graphic elements, are encapsulated into a single file. The graphic elements are not encoded to a specific operating system, software application, or hardware, but are designed to be rendered in the same manner regardless of the specificities relating to the system writing or reading such data. The cross-platform capability of PDF aided in its widespread adoption, and is now a de facto document exchange standard. Although originally proprietary, PDF has been released as an open standard published by the International Organization for Standardization (ISO) as ISO/IEC 3200-1:2008. Currently, PDF is utilized to encode a wide variety of document types, including those composed largely of text, and those composed largely of vector and raster graphics. Due to its versatility and universality, files in the PDF format are often preferred over more particularized file formats of specific applications. As such, documents are frequently converted to the PDF format.

From the user interface perspective, PDF documents are typically rendered as a static, graphical image, in which individual elements thereof such as text, pictures, and other elements are not editable. However, one of several improvements that have been made since the initial releases of PDF readers, writers, and the standard itself, is the support for adding annotations to a base document. Such annotations are graphically overlaid or “placed” on the underlying document, with placement being precisely controlled by the user. Thus, the functionality is similar to graphic illustration/design and image manipulation applications where various objects can be positioned on a document canvas by navigating a cursor to a desired location and providing a subsequent input to make placement permanent. Before positioning the cursor, the object to be placed, such as a geometric primitive, a text box, or the like, is selected.

Conventional implementations of the annotation feature are used to facilitate a linear workflow, where one user creates an initial version of a document, and distributes/e-mails the same to colleagues for review, comments, and amendments. Thereafter, upon receiving comments and amendments, the primary author incorporates them in to the document, and distributes it again in a second revision cycle. For uncomplicated collaboration environments that involve a minimal number of participants and a one-to-many hierarchy where there is little interaction among the downstream participants, this approach is adequate. With the addition of participants, and a change in the workflow hierarchy to many-to-many where the participants carry on several concurrent revision dialogues, the conventional implementation quickly becomes unmanageable. Numerous versions of the document may be distributed to participants, and it is uncertain if the version that one participant is working on is, indeed, the latest version existing amongst all of the participants. For example, it is possible for one user to interrupt the chain of revisions by working off an earlier version that did not incorporate any subsequent revisions that may have been made by others. Even though that version may be the latest in time, it does not reflect the latest in the progress of the document. This problem is compounded as additional participants make revisions to the incorrect latest version of the document. Although procedural discipline may be enforced in the workflow, the integrity of the process nevertheless depends upon the human factor, and is thus subject to a significant risk of error.

One alternative to the foregoing cyclical collaboration practice is real-time conferencing, where a single primary participant hosts several secondary participants. This is also known as application sharing, where the primary participant manipulates the document directly through a local application, while the secondary participants are presented with a dynamically updated view of the application as the document is edited. It is possible for the secondary participants to manipulate the document by remote input and temporarily taking control of the application. There are several limitations, however, the first being the substantial bandwidth requirements to transmit what is essentially video data to the remote participants. Since the conference is conducted in real-time, by definition, it requires that all participants be at least partially engaged during the conference. Therefore, it may not be as convenient to the participants as the previously described document distribution approach where revisions and comments may be made as the various participants' time allows.

Because conventional collaboration approaches are deficient for a variety of reasons as noted above, there is a need in the art for asynchronous and synchronous collaboration systems that involve communication methods, such as document annotations and chat messaging, that associate that data to visual content as a means to provide context and visual perspective.

### BRIEF SUMMARY

In accordance with one embodiment of the present disclosure, a method for coordinating visual content annotation is contemplated. The method may begin with a step of establishing a collaboration session from a collaboration server with a plurality of participant nodes. There may also be a step of transmitting the visual content to the participant nodes from the collaboration server. Additionally, there may be included a step of receiving a session data object at the collaboration server from a first one of the plurality of participant nodes. The session data object may include view parameters specific to a display of the visual content on the first one of the plurality of participant nodes. The method may also include a step of generating a session record entry associated with the received session data object. The session record entry may include the associated view parameters. There may also be a step of transmitting the record entry from the collaboration server to one or more of the other ones of the plurality of participant nodes.

Another embodiment of the present disclosure provides a method for collaborating from a local node on visual content viewable by a plurality of users on remote nodes. The method may include transmitting the visual content to a remote collaboration server from the local node. The visual content may be associated with a collaboration session. Furthermore, there may be a step of receiving a local data object associated with the visual content on the local node. The visual content may be displayed on the local node in accordance with a set of local view parameters particular to the receipt of the local data object. The method may also include generating a session data object from the local data object on the local node. The session data object may include the set of local view parameters. There may be contemplated a step of transmitting the session data object and a broadcast request to the remote collaboration server from the local node. The broadcast request may be specifically associated with the transmitted session data object.

An alternative embodiment of the method for collaborating from a local node on visual content viewable by a plurality of users on remote nodes is also contemplated. The method may include receiving the visual content on the local node from a remote collaboration server. The visual content may be associated with a collaboration session. There may also be a step of receiving a session data object on the local node from the remote collaboration server, where the session data object may be associated with a first one of the remote nodes. The method may include generating on the local node an inventory of the received session data object and other prior received session data objects from other remote nodes in the collaboration session. Each of the session data objects may include a set of view parameters particular to the respective nodes with which it is associated. The method may also include receiving a selection of a one of the session data objects from the inventory on the local node. Furthermore, there may be a step of displaying the visual content on the local node in substantial conformity with the set of view parameters of the selected one of the session data objects.

Thus, the session data objects, which may include annotations overlaid on the visual content, as well as separately displayed text chat messages, are associated with the particular view on the local node from which it originates, when it is generated, as defined in the view parameters. This view can be replicated on the receiving local nodes, providing full context to the collaboration session as new session data objects are exchanged.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an exemplary environment including a collaboration server and one or more client workstations;

FIG. 2 is an exemplary client workstation that may be capable to perform functions for use with aspects of the present invention including a display monitor, a system unit, and input/output devices;

FIG. 3 is a block diagram showing the various components of the system unit in the exemplary client workstation of FIG. 2;

FIG. 4 is an exemplary graphical user interface of a software application for annotating visual content;

FIG. 5 is a flowchart illustrating a method for coordinating visual content annotation in accordance with one embodiment of the present disclosure;

FIG. 6 is a flowchart illustrating one method for collaborating on visual content viewable by a plurality of users on remote nodes;

FIG. 7 is a flowchart illustrating another method for collaborating on visual content viewable by a plurality of users on remote nodes;

FIG. 8 is an example session window for starting or joining collaboration sessions;

FIG. 9 is an example dialog box for starting a new collaboration session;

FIG. 10 is an example dialog box for inviting participants into the newly defined collaboration session;

FIG. 11 is a block diagram illustrating the different layers of data objects associated with the collaboration session including a local document layer, a phantom document layer, and a local display environment;

FIG. 12 is one visualization of an inventory of received session data objects in a record sub-window;

FIG. 13 is an example of a first workspace window associated with an originator;

FIG. 14 is an example of a second workspace window associated with a recipient illustrating and adjusted view that is in substantial conformity with view parameters of the first workspace window shown FIG. 13; and

FIG. 15 is an exemplary session report.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities.

A method for coordinating visual content annotation is disclosed in accordance with various embodiments of the present invention. There are also disclosed methods for collaborating on visual content viewable by a plurality of users on remote nodes. In general, these methods involve multiple users working on one or more documents at the same time, i.e., synchronously, or at different times, i.e., asynchronously from a unitary interface. Additional details of these methods will be discussed more fully below. It is understood that these methods may be implemented as one or more computer-executable instructions that can be stored on a data storage medium.

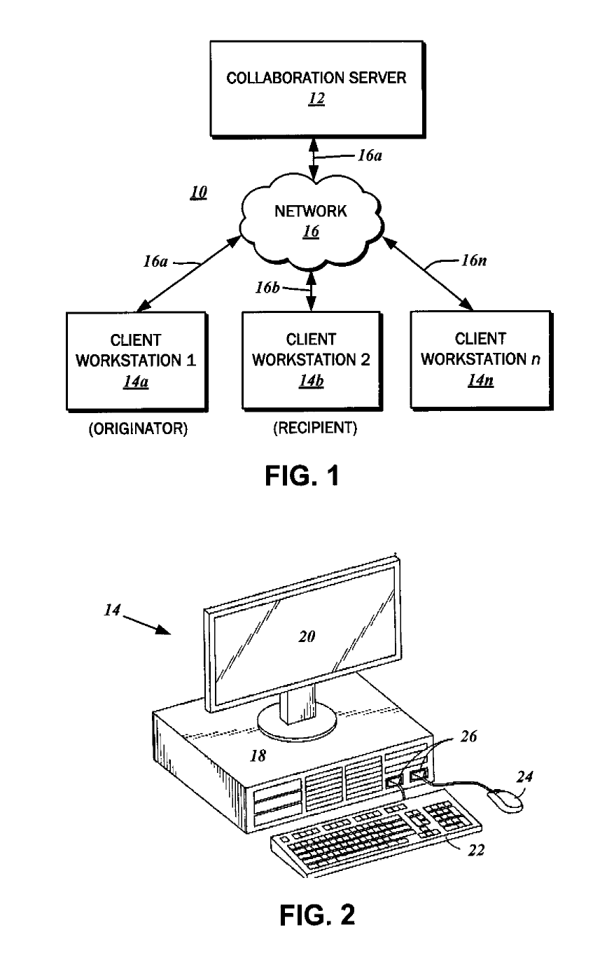

The block diagram of FIG. 1 shows an exemplary environment 10 in which the method for coordinating visual content annotation may be implemented. Specifically, there is a collaboration server 12 that is in communication with one or more client workstations 14a-14n over the network 16. It is contemplated that the network 16 interconnects client workstations 14 that are remotely located, and thus may be the Internet or other type of wide area network, though local area implementations are also contemplated. Network connections 16a-16n may thus be Internet Protocol Suite-compliant with a Transmission Control Protocol (TCP) component as well as a User Datagram Protocol (UDP) component. Depending on the needs of the services involved, the more reliable and ordered (albeit slower) delivery of data possible through a TCP connection may be more appropriate, or the faster but more unreliable delivery of data through a UDP connection may be more appropriate. Although any network modality may be utilized to transfer data from the client workstations 14 to the collaboration server 12 and vice versa, it will be appreciated that certain improvements may be realized if the protocol selection is tailored to the particular needs. Where an embodiment contemplates such a selection, those will be particularly noted. Along these lines, the specific network topology is presented by way of example only, however, and any other type of arrangement may be substituted.

The collaboration server 12 is understood to be a conventional server computer system having a processor capable of executing the noted instructions of the method, as well as a memory for storing the instructions and other related data. As part of its functionality of communicating with the client workstations 14 over the network 16 in some embodiments, the collaboration server 12 may be a web server including commercially available application or web services components such as the Windows Communication Foundation (WCF) from Microsoft Corporation of Redmond, Wash.

With reference to FIG. 2, one exemplary embodiment of the client workstation 14 may include a system unit 18 and a display monitor 20. The display monitor 20 graphically displays output from the data processing operations performed by the system unit 18. The display monitor 20 is a visual output device and includes some form of screen. The display monitor 20 may be of a Liquid Crystal Display (LCD) type, a Cathode Ray Tube (CRT) type, or any other suitable type of display. Devices such as a keyboard 22 and a mouse 24 are utilized to provide input to the data processing operations, and are connected to the system unit 18 via USB ports 26. Various other input and output devices may be connected to the system unit 18, and alternative interconnection modalities may be substituted with the USB ports 26.

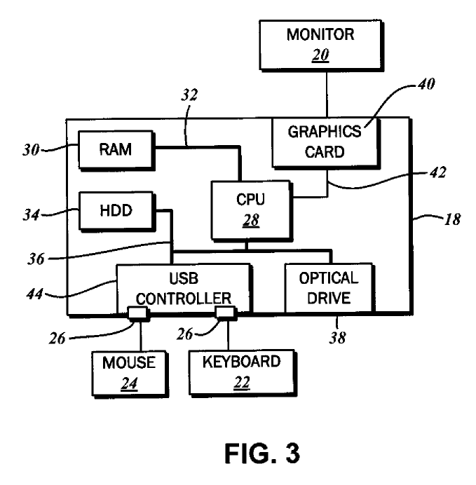

As shown in the block diagram of FIG. 3, the system unit 18 includes a Central Processing Unit (CPU) 28, which may represent one or more conventional types of such processors, such as an IBM PowerPC, Intel Pentium (x86) processors, and so forth. A Random Access Memory (RAM) 30 temporarily stores results of the data processing operations performed by the CPU 28, and is interconnected thereto typically via a dedicated memory channel 32. The system unit 18 may also include permanent storage devices such as a hard drive 34, which are also in communication with the CPU 28 over an input/output (I/O) bus 36. Other types of storage devices 38 such as tape drives, Compact Disc drives, and the like may also be connected. A graphics card 40 is also connected to the CPU 28 via a video bus 42, and transmits signals representative of display data to the display monitor 20. As indicated above, the keyboard 22 and the mouse 24 are connected to the system unit 18 over the USB port 26. A USB controller 44 translates data and instructions to and from the CPU 28 for external peripherals connected to the USB port 26. Additional devices such as printers, microphones, speakers, and the like may be connected to the system unit 18.

The system unit 18 may utilize any operating system having a graphical user interface (GUI), such as WINDOWS from Microsoft Corporation of Redmond, Wash., MAC OS from Apple, Inc. of Cupertino, Calif., various versions of UNIX with the X-Windows windowing system, and so forth. The system unit 18 executes one or more computer programs, with the results thereof being displayed on the display monitor 20. Generally, the operating system and the computer programs are tangibly embodied in a computer-readable medium, e.g. one or more of the fixed and/or removable data storage devices including the hard drive 34. Both the operating system and the computer programs may be loaded from the aforementioned data storage devices into the RAM 30 for execution by the CPU 28. The computer programs may comprise instructions, which, when read and executed by the CPU 28, cause the same to perform or execute the steps or features of the various embodiments set forth in the present disclosure.

According to one embodiment, a user can interact with client workstation 14, specifically with the graphics being displayed on the monitor 20, via the mouse 24. The movement of a cursor generated on the monitor 20 is tied to the movement of the mouse 24, with further interactivity being provided with input from the mouse buttons. Input from the keyboard 22 also provides interactivity with the client workstation 14. This description refers to “clicking” the mouse buttons, “positioning” the cursor, “holding” the mouse button to “drag” an on-screen object, and so forth. It will be appreciated by those having ordinary skill in the art that such terms have well-understood meanings relative to interactions with the client workstation 14 through a graphical user interface, and also find correspondence to other input modalities such as pen/digitizers and the like.

The foregoing client workstation 14 represents only one exemplary apparatus suitable for implementing aspects of the present invention. As such, the client workstation 14 may have many different configurations and architectures. Any such configuration or architecture may be readily substituted.

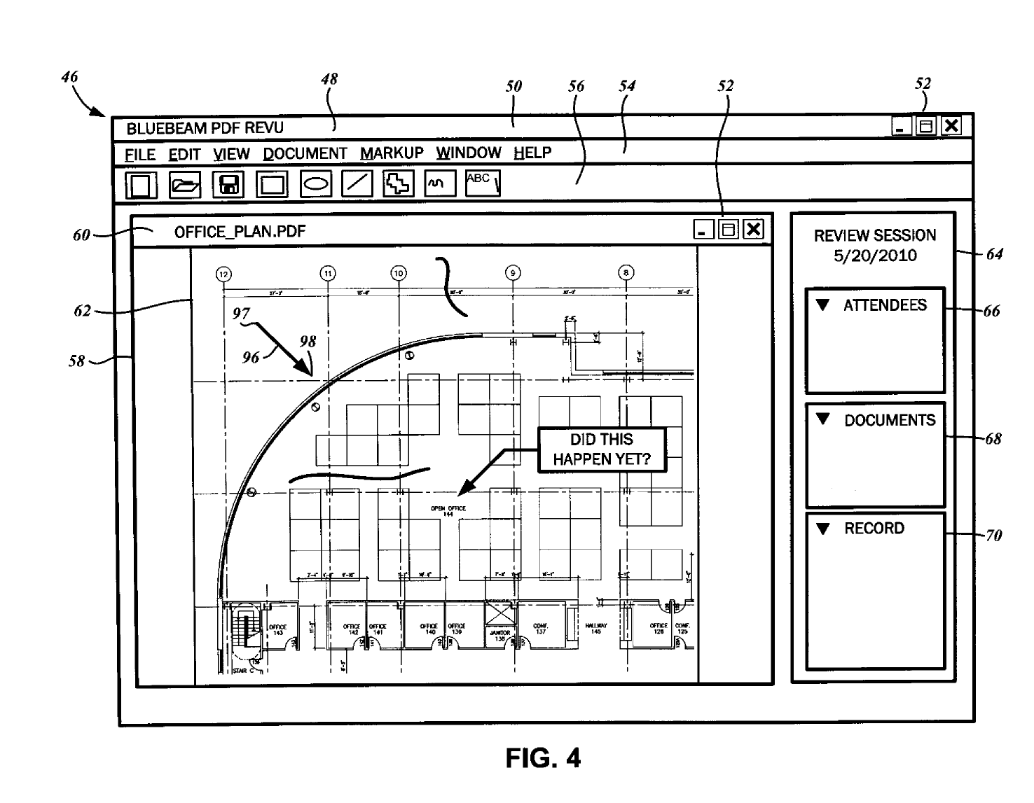

FIG. 4 illustrates one exemplary graphical user interface 46 of a software application for collaboratively reviewing and annotating visual content. In one exemplary embodiment, the visual content is a Portable Document Format (PDF) document that includes text and graphics. However, as utilized herein, the term visual content is intended to encompass any other types of information that can be displayed on the monitor 20, such as word processing documents, spreadsheets, photographs, graphics layouts, three-dimensional models, video, graphical content such as medical X-ray images, and so forth. While various exemplary embodiments set forth below are described in relation to the PDF application, it will be appreciated that the same features may be incorporated into other software applications for different visual content. As indicated above, the software application runs on a windowing system, and accordingly has a number of interface elements that are common to such applications. Each of the participating client workstations 14 are understood to have a copy of the software application installed thereon. The copies of the software application need not be identical, however, and some client workstations may have a copy with a differing set of functionalities than another such as with trial versions, reader-only versions, and so forth. Those having skill in the art will recognize that the software application is understood to refer to any software program embodying the contemplated methods of the present disclosure.

In further detail, the functional, interactive features of the graphical user interface 46 are contained within a main window 48 that includes a title bar 50 with basic window controls 52 that variously minimize, maximize, and close the main window 48. In addition, the main window 48 includes a menu bar 54, from which various functions of the reviewing software application may be invoked via activated pull-down menus. So that commonly utilized functions such as opening files, saving changes to the currently opened file, and so forth are readily accessible, there is also a tool bar 56. It is contemplated that annotations of various types can be placed and manipulated via the graphical user interface 46. Selection of the annotation type may be made with the respective icons of the tool bar 56.

Annotations are understood to be a type of data object that is associated with an underlying document, and generally refers to a conceptual entity corresponding to a contiguous block of memory at a specific location and with a specific size, and is defined by one or more properties that define its characteristics. It is understood that an annotation can be a geometric primitive such as a point, a line (single segment or multi-segment), an ellipse, a polygon, or the like, as well as specialized annotation object such as callout boxes. To further define the features of the annotation, various parameter attributes can be associated therewith such as dimensions, color, line thickness, positioning coordinates, and others that are specific to that annotation type. Although annotations are stored in the document, they generally do not become a part of the document; visually, the annotations are overlaid on a separate layer of the document.

Within the main window 48 is a workspace window 58, which includes a sub-title bar 60 and basic window controls 52. There is a document 62 that is rendered within the workspace window 58. In the example shown, the document 62 is an architectural drawing comprised of various graphical elements including lines, arcs, text. Within the sub-title bar 60, there may be a descriptor of the document 62, which is named “OFFICE_PLAN.PDF.” Although in the exemplary embodiment the document is a PDF file structured in accordance with the standard as discussed above, it is expressly contemplated that any other desired document format may be rendered in the workspace window 58.

Specific to the collaboration features contemplated in the present disclosure, the graphical user interface 46 also includes a session window 64. Within the session window 64 is an attendee sub-window 66 that lists the participants in the collaboration session, as well as a documents sub-window 68 that lists the documents being reviewed and annotated in the collaboration session. There is also a record sub-window 70 that lists each of the actions and chat dialogues occurring during the collaboration session. Further details regarding the contents of these sub-windows will be considered below, and the uses for the same will become apparent. The specific visual appearance and arrangement of the session window 64 and its constituent sub-windows has been presented by way of example only and any other configuration may be readily substituted.

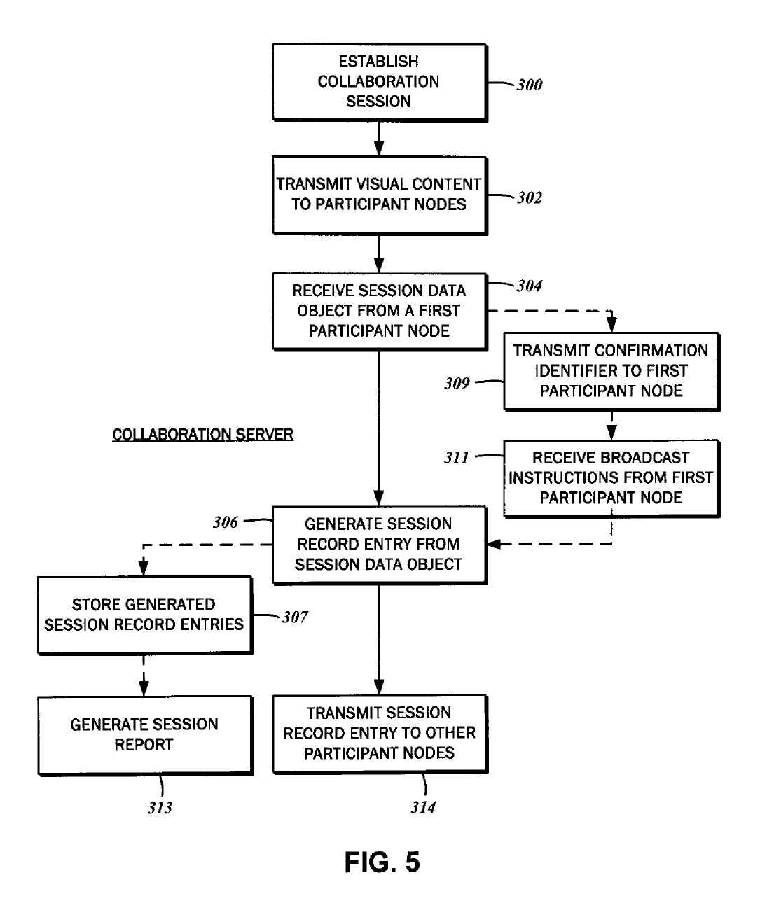

Various aspects of collaboration on visual content are contemplated from the perspective of a first client workstation 14a, which is designated as the originator, from the perspective of a second client workstation 14b, which is designated as the recipient, and from the perspective of the collaboration server 12, which manages the interaction between the originator and the recipient. The flowcharts of FIGS. 5, 6, and 7 illustrate the steps of the various methods that are specific to those aspects. However, the steps of such methods are understood not to take place concurrently in the overall collaboration workflow; for example, the first step from the perspective of the originator does not necessarily correspond to the first step from the perspective of the recipient. Accordingly, the steps will be described in relation to a typical exemplary workflow and their relation to other, prefatory steps that are optional, and therefore omitted, from the flowcharts.

With reference to the flowchart of FIG. 5, the collaboration workflow begins with a step 300 of establishing a collaboration session. A collaboration session is generally understood to be an interactive exchange of comments (chat messages), annotations, and other such data between the client workstations 14, which are participants in that collaboration session. The collaboration session may be defined by one or more documents that are reviewed and/or manipulated, and by the participants involved. Additionally, each collaboration session may have associated therewith permissions as to which participants can join that collaboration session, and the identity of the participant initiating that collaboration session. Information for each defined collaboration session is stored in the collaboration server 12, which may be hosted by a third party independent of the client workstations 14, or by the same entity that owns or manages the client workstations 14.

In accordance with various embodiments of the present disclosure, a collaboration session can span an indefinite period of time, that is, once initiated, a session is accessible for other participants to join and exit until a record thereof is removed from the collaboration server 12. The collaboration session is asynchronous because it is not necessary for each of the participants to join at the same time to work on the document. However, if desired, the participants can join simultaneously, or in a synchronous collaboration session, to work on the document in real-time. Various embodiments of the present disclosure contemplate features that enable such asynchronous/synchronous collaboration sessions.

In an alternative representation of the session window 64, the user is provided with an option to start a new session by selecting a start icon 72, or joining an existing session by selecting a join icon 74. To the extent that the client workstation 14 is already connected to an existing session, a disconnect icon 76 can be selected to exit the session. Within the session window 64, a list of sessions started by the user is shown in a “my sessions” section 78, while a list of other sessions joined by the user is shown in an “attended sessions” section 80. By selecting an entry from either of these sections, the corresponding session can be joined.

As best shown in an exemplary dialog box 82 shown in FIG. 9, a variety of parameters for the new collaboration session may be set therein. A name identifying the collaboration session may be entered into a session name input 84. The name entered therein is what will be displayed in the list of sessions in the session window 64, above. The various documents that are to be the part of the collaboration session are specified in a file selection list 86. Permissions for the participants to save the documents, print the documents, and add annotations or markups are specified in a set of checkboxes 88a-c, respectively. The permitted participants may be restricted according to specified e-mail addresses by the selection of a checkbox 88d, and the originator may be notified by e-mail by the selection of a checkbox 88e.

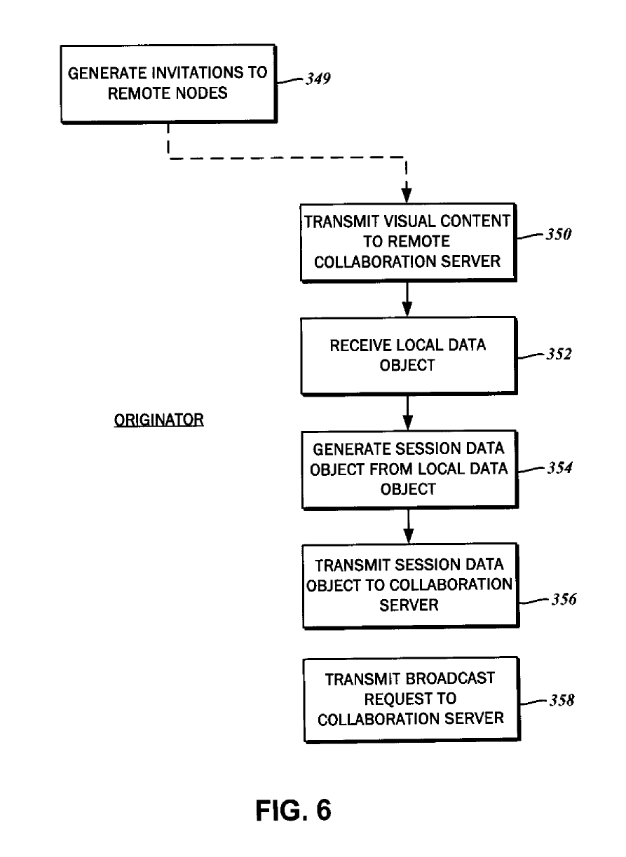

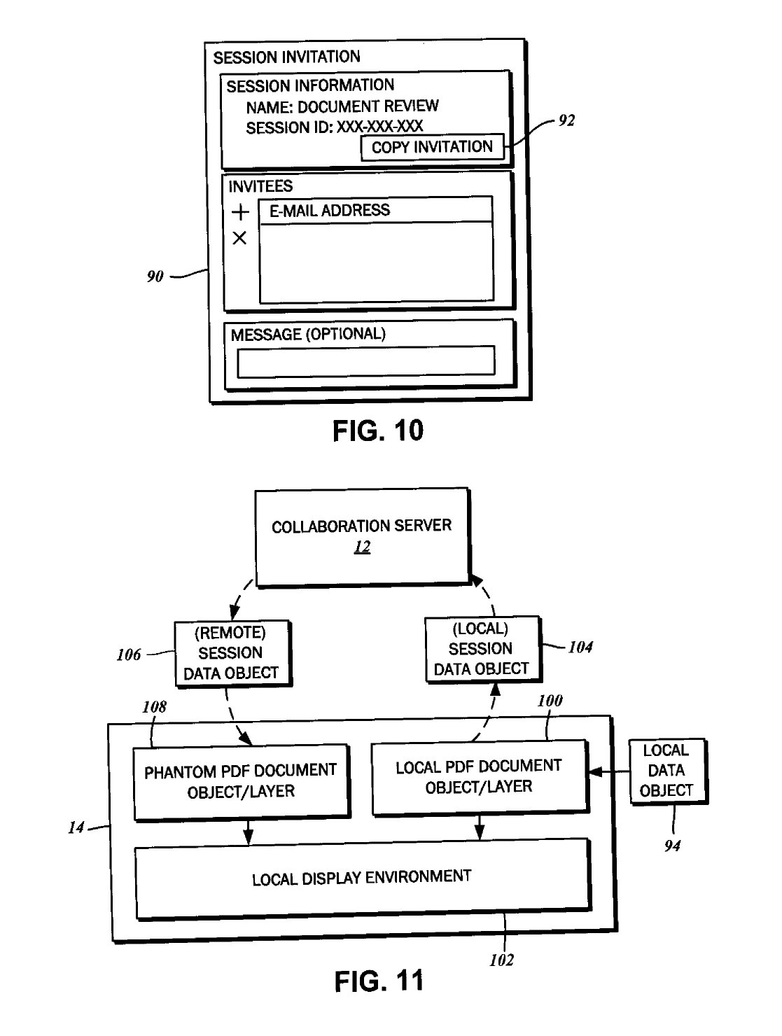

Referring now to the flowchart of FIG. 6, from the perspective of the originator 14a, the method of collaborating on visual content as pertinent thereto may include a prefatory step 349 of generating invitations to remote nodes such as the recipient 14b. The invitations are to join the collaboration session specified in the invitation. FIG. 10 illustrates an example dialog box 90 in which e-mail addresses of invited participants can be entered. In this situation, the invited participants are sent an e-mail at the specified addresses/accounts by the collaboration server 12. Alternatively, a specific link to the collaboration session may be generated by clicking a copy invitation button. It is contemplated that this link may be in the form of a Uniform Resource Identifier (URI) specifying the network address of the collaboration server 12, along with the unique session identifier mentioned above. The link may be in any other suitable format that can be copied into a clipboard memory as text, and pasted on to various communications modalities such as e-mail or instant messages.

After starting the collaboration session, the method from the perspective of the originator 14a may continue with a step 350 of transmitting the visual content to the collaboration server 12 and associated with the specific collaboration session as described above. As the originator 14a, the authoritative version of the visual content resides thereon, and so that is the version that is propagated to the other participants via the collaboration server 12. Referring to the flowchart of FIG. 5 the method from the perspective of the collaboration server 12 continues with a step 302 of transmitting the visual content or document 62 to the client workstations 14, and in particular, to the recipient 14b. In a related step in the method from the perspective of the recipient 14b, there is a first step 400 of receiving the visual content from the collaboration server 12. Once received, the document 62 may be displayed in the workspace window 58. To the extent that there are other documents or visual content that are defined as being part of the collaboration session, such data is also propagated to the participants in the manner above. Multiple documents may be loaded in separate workspace windows 58 in a tabbed interface, or any other suitable display arrangement known in the art.

With reference to the block diagram of FIG. 11 and the flowchart of FIG. 6 the method from the perspective of the originator 14a includes a step 352 of receiving a local data object 94 that is to be associated with the visual content or document 62. More particularly, with reference to FIG. 4, this may involve receiving user input via the graphical user interface 46 corresponding to the placement of an annotation 96 on the document 62. In this regard, the term local data object is understood to include the annotation 96, among other types of objects that can be associated with the document 62. This may also include text chat data that can be typed in to the record sub-window 70 by the user. By way of example only, the annotation 96 is a line with an arrow tip, and placement may begin with navigating a mouse cursor to a desired starting location 97 within the document 62, clicking, and then dragging the cursor to a desired ending location 98. As indicated above, there are many other types of annotations that may be placed on the document 62.

When the annotation 96 is placed on the document 62, the workspace window 58 has a particular set of view parameters that defines the way in which the document 62 is displayed. These include client workstation-level settings such as the dots-per-inch settings of the display monitor 20. Additionally these may include graphical user interface-specific settings such as the width and height of the main window 48 or the workspace window 58, the zoom factor of the document 62 as displayed in the workspace window 58, and the page rotation settings. The view of the document 62 as navigated to by the user are also contemplated to be view parameters, and includes vertical and horizontal offset from a known anchor point (center, upper left corner, etc.) of the document 62, the page number currently displayed, and the display type, or how the document 62 is displayed within the workspace window 58. These include fit width, where the size of the contents of the document 62 are enlarged to an extent where the width of the document 62 fits the entirety of the width of the workspace window 58, as well as fit page, where the contents of a single page of the document 62 fits within the confines of the workspace window 58, and continuous mode, where consecutive pages of the document 62 are rendered as a single sheet. These and other display types for the document 62 as shown on the workspace window 58 are also contemplated. It is understood that at any given point in time when a user input is received, and particularly when the annotation 96 is placed on the document 62, there is an associated set of view parameters that defines the way the document 62 is shown at that instant. As will be described in greater detail, various embodiments of the present disclosure contemplate the transfer of these view parameters to the recipients 14b so that the view on the originator 14a is substantially replicated thereby.

With reference to the block diagram of FIG. 11, the annotation 96 or local data object 94 is placed into a local document object or layer 100. It is understood that any local data object 94 placed in the local document object/layer 100 are editable by the local user, and new local data objects may be added as desired. Additionally, existing local data objects may be deleted from the local document object/layer 100. The local document object/layer 100 is displayed in the local display environment 102 that includes the document 62 that is displayed in accordance with the set of view parameters as discussed above. As noted above, chat text data may also be associated with the local document object or layer 100, though it is to be separately displayed in the record sub-window 70. According to one embodiment, such chat text data is not editable once entered, but it is also contemplated that edits and deletions may be made in the same manner as the annotation 96 if desired. The local data object 94 is stored together with the document 62 for subsequent retrieval and display.

From the local data object 94, a local session data object 104 may be generated in accordance with a step 354. The local session data object 104 is then transmitted to the collaboration server 12 per a step 356. This transmission is understood to occur over standard web service protocols and bindings. The step of transmitting the local session data object 104 has a corresponding step 304 from the perspective of the collaboration server 12, which involves receiving a session data object from the originator 14a (also referred to as a participant node). The set of view parameters as existing at the time of receiving the local data object 94 is included in the local session data object 104.

Following receipt of the local session data object 104, a session record entry associated therewith is generated in accordance with step 306. As indicated above, client workstations 14 can connect at different times and participate in an asynchronous collaboration session. Thus, the method also contemplates an optional step 307 of storing the generated session record on the collaboration server 12 for subsequent retrieval. In various embodiments, each of the session record entries received in the course of the collaboration session is stored in connection with the session parameters mentioned above such as the name of the session, invited participants, and so forth.

In an optional step 309, the collaboration server 12 may transmit a confirmation identifier to the client workstation 14 that sends the local session data object 104, i.e., the originator 14a. The confirmation identifier may be a unique number or other character sequence that particularly identifies the local session data object 104. This step may confirm to the originator 14a at that the transmitted local session data object 104 was indeed received by the collaboration server 12.

To propagate the local data object 94 to the other participating nodes including the recipient 14b, the method may have a step 358 of transmitting a broadcast request that is specifically associated to the local session data object 104 transmitted earlier. This step of transmitting the broadcast request may be in response to receiving the confirmation identifier from the collaboration server 12. The method from the perspective of the collaboration server 12 may include a further optional corollary step 311 of receiving the broadcast request or instructions from the originator 14a. The broadcast request may include the received confirmation identifier, and effectively instructs the collaboration server 12 to transmit the received local session data object 104 to the other nodes. The broadcast request may be transmitted via a TCP channel to ensure reliable data transfer.

As noted above, the steps of exchanging the confirmation identifier and the broadcast request are optional. It is understood that transmitting the local session data object 104 may itself be handled as a broadcast request, so the separate delineation of the steps is presented as one exemplary example of how the methods may be implemented.

In a step 314, the session record entry, which includes the local session data object 104 from which it is derived, and the associated view parameters are transmitted to the other participant nodes, including the recipient 14b and any other client workstations 14 that are a part of the collaboration session. From the perspective of the recipient 14b, there is a corollary step 402 of receiving that session data object. In accordance with one embodiment of the present disclosure, this step is accomplished over the web service connection. With reference again to the block diagram of FIG. 11, considering that the session data object is not, by definition, local to the second client workstation 14b, it is designated as a remote session data object 106.

Generally, the recipient 14b updates the graphical user interface 46 to reflect the received remote session data object 106. Continuing with the example sequence above, the line annotation 96 added to the document 62 on the originator 14a is transferred to the collaboration server 12 by way of the local session data object 104. The corresponding remote session data object 106 includes the line annotation 96, which is displayed on the recipient 14b in the same or substantially the same way as in the originator 14a. As best illustrated in the block diagram of FIG. 11, the received remote session data object 106 is stored in a phantom document object/layer 108 that is independent of the local document object/layer 100. It is understood that all received remote session data objects 106 may be placed in the phantom document object/layer 108. Any annotations 96 in the phantom document object/layer 108 are locked to the local user, and cannot be edited or deleted. As will be described more fully below, the phantom document object/layer and the local document object/layer 100 are overlaid on the document 62 as displayed in the workspace window 58. The annotations can be overlaid or displayed on the document 62 immediately upon receipt into the phantom document object/layer 108.

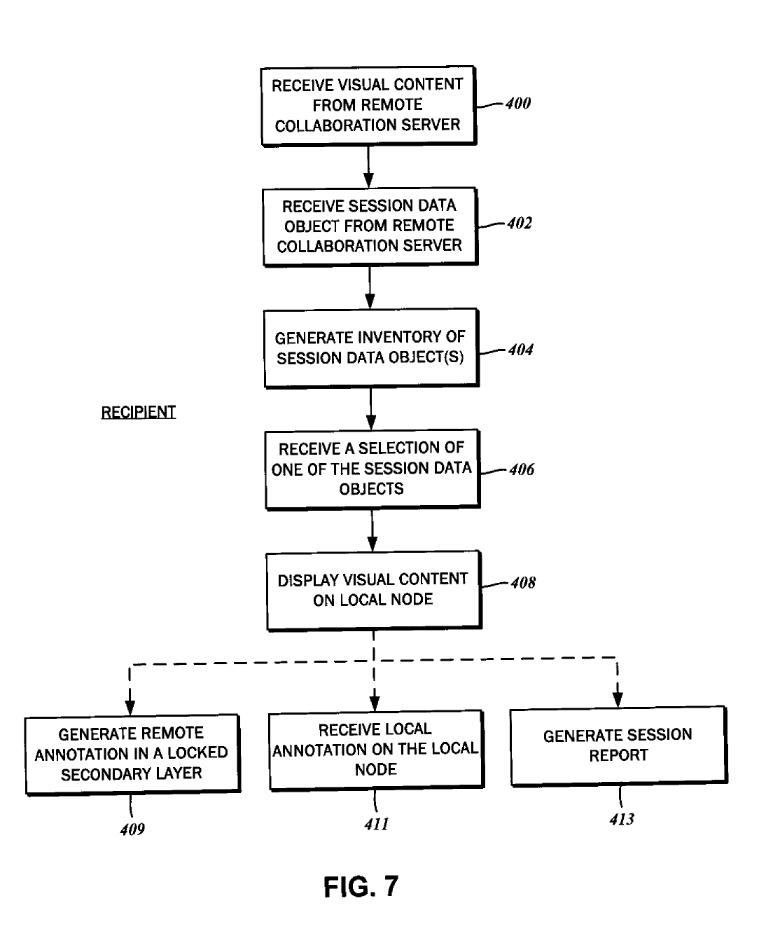

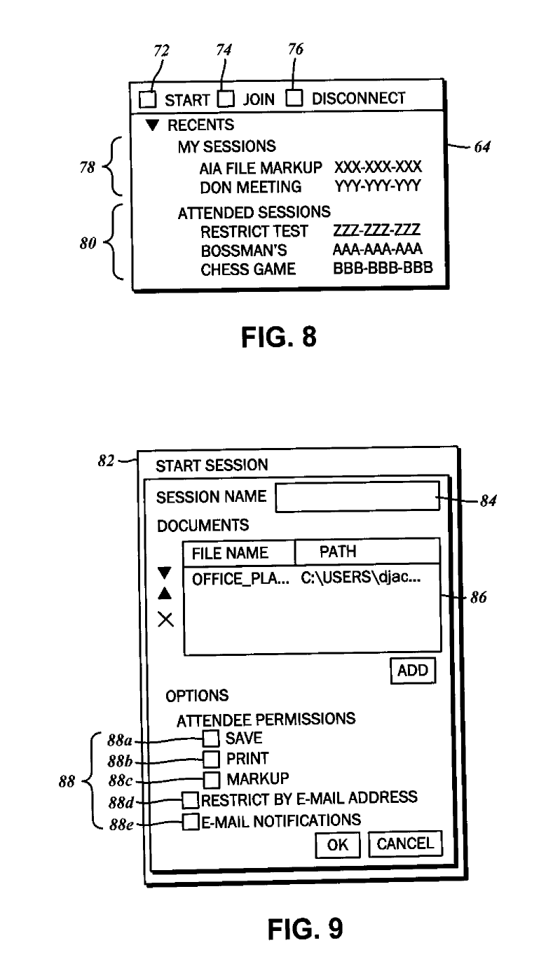

Referring again to the flowchart of FIG. 7, after receiving the remote session data object, the method continues with a step 404 of generating an inventory of all remote session data objects, which includes the most recently received remote session data object 106, as well as other prior received remote session objects. To the extent that remote session data objects were received from other nodes besides the originator 14a, those would be included in the inventory as well. This part may take place at the very beginning of establishing the collaboration session with each newly received remote session data object being added to the inventory, instead of refreshing the entirety of the inventory each time.

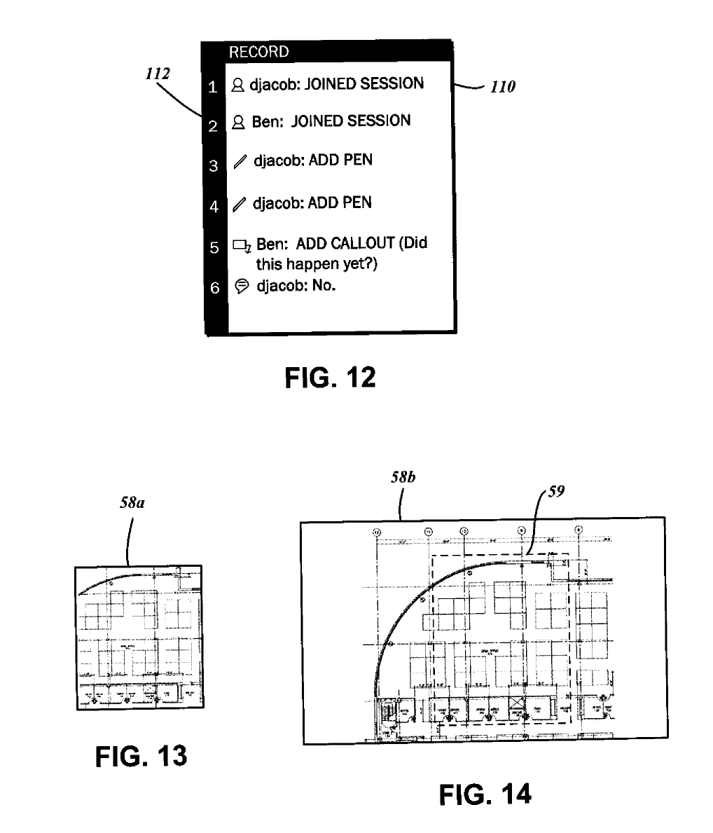

In one contemplated embodiment, the inventory may be visualized in the aforementioned record sub-window 70 in the graphical user interface 46. A further detailed view of an inventory listing 110 is shown in FIG. 12. The inventory listing 110 may include a sequence identifier 112 that designates the order in which the remote session data objects, among others, were received. This embodiment also contemplates that other actions besides the adding of annotations is recorded, including participants logging in to the session, and so forth. In the exemplary inventor listing 110, two users “djacob” and “Ben” have joined the session, as indicated in lines 1 and 2. As mentioned above, in the example sequence, a line is added by the originator 14a. This is indicated in the inventory listing 110 as “ADD PEN” in lines 3 and 4, and is noted as being initiated by the user “djacob.” An icon representative of the type of event that occurred, or session data object is also provided; in this instance, it is a pen-shaped object. For other annotations, such as the callout box that was added by user “Ben” indicated in line 5, the corresponding icon of a callout box is shown. Furthermore, because a callout box is capable of accepting supplemental text, that is also provided in the listing: “Did this happen yet?”

The foregoing examples have been primarily in the context of session data objects with annotations that are added to the document 62, but it is expressly contemplated that session data objects can include text or chat messages that are exchanged amongst the client workstations 14. As an example, the sixth line of the inventory listing shows that the user “djacob” broadcasted a text message “No.” Although the examples above involve the derivation of the textual descriptions shown in the inventory listing 110 from the annotations in the received session data objects, it is also contemplated that the descriptions themselves are transmitted as text messages, with the annotations being included in that text message. Based upon the present disclosure, any number of different implementations may be utilized. Such text messages are also understood to be accompanied by the set of view parameters. In addition to text messages and annotations, the session data objects may include pre-recorded audio or video messages, or any other type of content that may be displayed or otherwise reproduced on the client workstation 14.

The method further includes a step 406 of receiving a selection of one of the session data objects in the inventory. This may be accomplished by clicking on one of the session data objects as represented in the inventory listing 110. That the session data object may be selected independently of the initial transfer of the local session data object 104 to the collaboration server 12 refers to asynchronous collaboration. However, in some embodiments, it is also envisioned that the selection may occur without user intervention, upon receipt of the session data object in step 402. This is referred to as synchronous collaboration. It will be appreciated that the above-described method provides both asynchronous and synchronous collaboration on visual content from the same interface, specifically the inventory listing 110.

For each of the session data objects included in the inventory listing 110, there is an associated set of view parameters of the originator 14a, at the time it is sent. Therefore, upon a selection of one of the session data objects from the inventory listing 110, the associated set of view parameters is then applied to the recipient 14b. The various individual view parameters that may be included such as DPI settings and the like have been described, so they will not be described again here.

The method from the perspective of the recipient 14b continues with a step 408 of generating the visual content or document 62 thereon in substantial conformity with the associated set of view parameters. Essentially, this means that the workspace window 58 of the recipient 14b is updated to appear as close as possible to the workspace window 58 of the originator 14a. For example, if the view is zoomed in to a particular section of the document 62, then that zoomed view will be replicated. Thus, the chat record, as well as the record of annotations being added, is capable of tracking or following the view of the originator as the collaboration session progresses, with that view being replicated on the recipients. The recipient thus “sees” the document as “seen” by the originator, providing full visual context to the circumstances in which certain comments or annotations were made.

FIG. 13 provides an illustrative example of a first workspace window 58a that has a particular view as defined by the aforementioned view parameters, and has a certain predefined size. FIG. 14 provides an illustrative example of a second workspace window 58b that is replicated from the first workspace window 58a, but has a larger predefined size. In this instance, where the second workspace window 58b represents a display on the recipient 14b, it is adjusted to match the view on the first workspace window 58a, accounting for the originator's DPI settings and screen resolution settings. In accordance with one embodiment, the second workspace window 58b shows at least as much of the document 62 as shown in the first workspace window 58a, but likely see more because there is a larger area within which the document 62 is displayed. As shown in the second workspace window 58b, a portion 59 of the document 62 corresponds to the view shown in the first workspace window 58a.

In addition to designating a specific location on the document 62 to which the workspace window 58 is focused, it is understood that the set of view parameters includes a designation of a particular document amongst others that are part of the collaboration session. Thus, if one of the session data objects pertains to a different document, then the workspace window 58 is loaded with that different document, and the view is adjusted to conform to the remaining view parameters in the same manner as previously described.

As indicated above, an annotation in the received remote session data object 106 may be placed into the phantom document object/layer 108 immediately upon receipt and displayed, per step 409. This is understood to be independent of adjusting the display of the visual content to be in substantial conformity to the associated set of view parameters, but in accordance with various other embodiments, it may be generated upon receipt of the selection of a specific one of the session data objects. Along these lines, because the inventory is arranged in the order received, a later-added annotation or session data object may not be displayed if an earlier received annotation or session data object is selected. For example, if the third element in the inventory listing 110 is selected, then only the annotation corresponding to the first “ADD PEN” descriptor is displayed. The other annotations corresponding to the second “ADD PEN” descriptor in the fourth line and to the “ADD CALLOUT” descriptor in the fifth line will not be displayed. However, if the sixth element in the inventory listing 110 is selected, then the view parameters describing the sixth element will be displayed.

The method from the perspective of the recipient 14b also includes a step 411 of receiving a local annotation and placing the same in to the local document object/layer 100. This is equivalent to the same step described in relation to the originator 14a. In this case, the recipient 14b becomes the originator, and the method continues as described above.

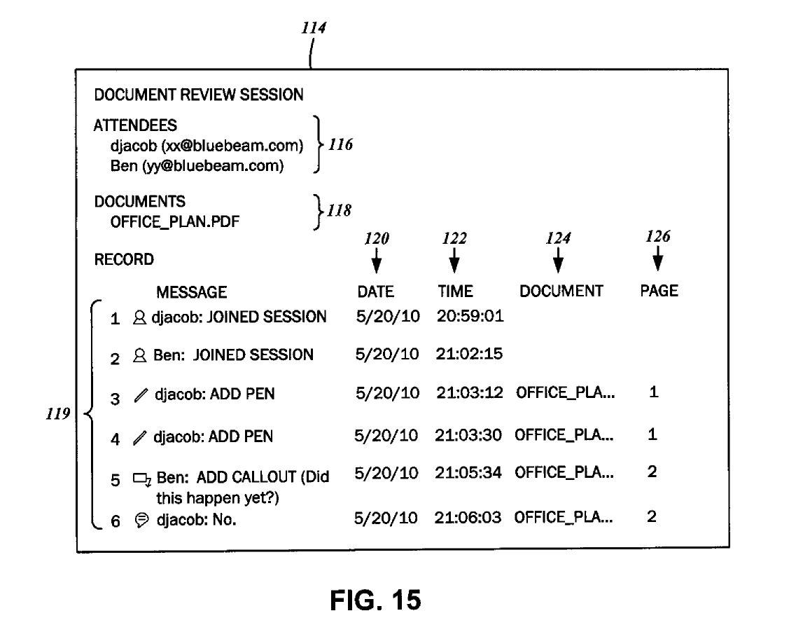

From the perspective of the collaboration server 12, as well as the recipient 14b, the respective methods contemplate an optional step 313, 413 of generating a session report. FIG. 15 shows an example of a session report 114. In further detail, there is a section 116 listing the participants of the session, here listed as user “djacob” and “Ben.” Optionally, the users' e-mail address may be included. There is also a section 118 listing the documents or visual contents that are a part of the collaboration session to which the session report 114 pertains. In the record section 119, the inventory listing described above in relation to 12 is replicated, and sets forth each of the session data objects that are a part of the collaboration session. Each row also includes a date column 120, a time column 122, a document identifier column 124, and a page identifier column 126. It is contemplated that the session report 114 is appended to the end of the document 62. To the extent that there are several documents in the collaboration session, each of those documents may be included in the session report 114. Each of the descriptors of the session objects are understood to be hyperlinked as is the case with the inventory listing 110. Thus, by selecting one of the session objects, the workspace window 58 displaying the document 62 is adjusted to that specified by the corresponding set of view parameters. It is also contemplated, however, that the session report 114 is separately generated from the document 62.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for coordinating visual content collaboration, comprising:
establishing a collaboration session from a collaboration server with a plurality of participant nodes;
transmitting the visual content to the participant nodes from the collaboration server;
receiving a session data object at the collaboration server from a first one of the plurality of participant nodes, the session data object including view parameters specific to a display of the visual content on the first one of the plurality of participant nodes;
generating a session record entry associated with the received session data object, the session record entry including the associated view parameters; and
transmitting the record entry from the collaboration server to one or more of the other ones of the plurality of participant nodes.

2. The method of claim 1, wherein the session data object includes a document annotation.

3. The method of claim 1, wherein the session data object is a broadcast chat message.

4. The method of claim 1, further comprising:
storing the generated session record entries of at least one of the received session data objects on the collaboration server.

5. The method of claim 4, further comprising:
generating a session report from all of the stored session record entries.

6. The method of claim 4, wherein session parameter data for the established collaboration session is stored in conjunction with the generated session record entries,

7. The method of claim 6, wherein the session parameters data is selected from a group consisting of: a session organizer identity and session participant permissions.

8. The method of claim 1, further comprising:
transmitting a confirmation identifier associated with the received session data object to the first one of the plurality of participant nodes from the collaboration server; and
receiving on the collaboration server broadcast instructions from the first one of the plurality of participant nodes based upon a successful receipt of the confirmation identifier;
wherein the record entry is transmitted to the other ones of the plurality of participant nodes in response to the broadcast instructions.

9. The method of claim 1, wherein the session data object is generated in response to user input associated with placement of a corresponding annotation on the visual content locally on the first one of the plurality of participant nodes.

10. The method of claim 1, wherein the session data object is generated in response to user input associated with entry of chat text separate from the visual content locally on the first one of the plurality of participant nodes.

11. The method of claim 1, wherein a one of the view parameters is selected from a group consisting of: dots-per-inch settings of the display device for the first one of the plurality of participant nodes, window width and height of the visual content as displayed on the first one of the plurality of participant nodes, zoom factor of the visual content as displayed on the first one of the plurality of participant nodes, rotation of the visual content as displayed on the first one of the plurality of participant nodes, offset of the visual content as displayed on the first one of the plurality of participant nodes, document page number of the visual content as displayed on the first one of the plurality of participant nodes, and display type of the visual content as displayed on the first one of the plurality of participant nodes.

12. A method for collaborating from a local node on visual content viewable by a plurality of users on remote nodes, the method comprising:
transmitting the visual content to a remote collaboration server from the local node, the visual content being associated with a collaboration session;
receiving a local data object associated with the visual content on the local node, the visual content being displayed on the local node in accordance with a set of local view parameters particular to the receipt of the local data object;
generating a session data object from the local data object on the local node, the session data object including the set of local view parameters; and
transmitting the session data object and a broadcast request to the remote collaboration server from the local node, the broadcast request being specifically associated with the transmitted session data object.

13. The method of claim 12, wherein the local data object is a document annotation overlaid on the visual content.

14. The method of claim 12, wherein the local data object is a broadcast chat message.

15. The method of claim 12, wherein the received local data object is stored in a data file of the visual content.

16. The method of claim 12, wherein the broadcast request is transmitted to the remote collaboration server in response to a verification message generated thereby confirming receipt of the session data object.

17. The method of claim 12, wherein a one of the set of local view parameters is selected from a group consisting of: dots-per-inch settings of the local node, window width of the visual content as displayed on the local node, zoom factor of the visual content as displayed on the local node, rotation of the visual content as displayed on the local node, offset of the visual content as displayed on the local node, page number of the visual content as displayed on the local node, and display type of the visual content as displayed on the local node.

18. The method of claim 12, further comprising:
generating invitations to each of the plurality of users on the remote nodes to join the collaboration session.

19. A method for collaborating from a local node on visual content viewable by a plurality of users on remote nodes, the method comprising:
receiving the visual content on the local node from a remote collaboration server, the visual content being associated with a collaboration session;
receiving a session data object on the local node from the remote collaboration server, the session data object being associated with a first one of the remote nodes;
generating on the local node an inventory of the received session data object and other prior received session data objects from other remote nodes in the collaboration session, each of the session data objects including a set of view parameters particular to the respective nodes with which it is associated;
receiving a selection of a one of the session data objects from the inventory on the local node; and
displaying the visual content on the local node in substantial conformity with the set of view parameters of the selected one of the session data objects.

20. The method of claim 19, wherein displaying the visual content on the local node further includes adjusting the view parameters of the local node to approximate the view on the one of the remote nodes associated with the selected one of the session data objects as defined by the set of view parameters thereof.

21. The method of claim 19, wherein the session data objects are each a remote annotation overlaid on the visual content.

22. The method of claim 21, further comprising:
generating the remote annotation in a locked secondary layer superimposed on the visual content on the local node.

23. The method of claim 22, further comprising:
receiving a local annotation on the local node, the local annotation being placed in an unlocked primary layer superimposed on the visual content;
wherein the local annotation is editable from the local node.

24. The method of claim 21, further comprising:
generating a session report including all of the remote annotations of the session data objects overlaid on the visual content.

25. The method of claim 19, wherein the session data object is a broadcast chat text message.

26. The method of claim 19, wherein the session data object is a pre-recorded audio message.

27. The method of claim 19, wherein the visual content is a portable document format (PDF) document.

28. The method of claim 19, wherein the visual content is a three-dimensional model.

29. The method of claim 19, wherein the selection of the one of the session data objects from the inventory is in response to receipt of the session data object from the remote collaboration server without user intervention.

30. The method of claim 19, wherein a one of the set of view parameters is selected from a group consisting of: dots-per-inch settings, window width and height of the visual content, zoom factor of the visual content, rotation of the visual content, offset of the visual content, page number of the visual content, and display type of the visual content.

31. An article of manufacture comprising a program storage medium readable by a computer, the medium tangibly embodying one or more programs of instructions executable by the computer to perform a method for coordinating visual content annotation, the method comprising:
establishing a collaboration session from a collaboration server with a plurality of participant nodes;
transmitting the visual content to the participant nodes from the collaboration server;
receiving a session data object at the collaboration server from a first one of the plurality of participant nodes, the session data object including view parameters specific to a display of the visual content on the first one of the plurality of participant nodes;
generating a session record entry associated with the received session data object, the session record entry including the associated view parameters; and
transmitting the record entry from the collaboration server to one or more of the other ones of the plurality of participant nodes.
